(19) United States
(12) Patent Application Publication
(10) Pub. No.: US 2005/0172776 A1
(43) Pub. Date: Aug. 11, 2005

(54) Guide for hand-held power saw

(76) Inventor: Alex T. Beleski, Surrey (CA)

Correspondence Address: Clifford W. Vermette, Vermette & Co.;Suite 230, Box 40, Granville Square, 200 Granville Street, Vancouver, BC, V6C 1S4, CA

(21) Appl. No.: 10/771,385

(22) Filed: Feb. 5, 2004

(51) Int. Cl. B23D 57/00

(52) U.S. Cl. 83/745; 83/574

(57) ABSTRACT

An apparatus for guiding a hand-held power saw for a precision cut. The guide may be used for obtaining accurate cuts at commonly used angles. Guiding strips and runners define the path of travel of the hand-held power saw to allow for a home-handyperson to easily and efficiently cut a workpiece.

### FIELD OF THE INVENTION

The present invention generally relates to an apparatus for guiding a hand-held power saw for a precision cut. More particularly, the present invention relates to a portable apparatus for guiding a hand-held power saw to consistently obtain straight and accurate cuts at commonly used angles.

### BACKGROUND OF THE INVENTION

There are various products available on the market for assisting an individual with obtaining precision cuts at various angles. However, most of these products are costly, difficult to use, and not very portable, and, therefore, impractical or unsuitable for the around-the-home handyperson.

Home handypersons are likely to own hand-held power saws. However, it can be difficult to align a workpiece and the hand-held power saw to obtain a cut at the correct angle. It is also difficult to maintain a straight cut by hand. A fine adjustment to a cut (e.g. shaving off 1/8 inches) is also very difficult to obtain by hand. As a result, it is desirable to have an inexpensive product that serves to align and guide a hand-held power saw for obtaining accurate and straight cuts at angles commonly desired by a home handyperson. Parameters for common use by a home handyperson would typically include a workpiece width of up to 5/2 inches and height of up to 1½ inches (the actual dimensions of a 2×6), and angles of ninety, thirty, forty-five and sixty degrees.

Previously disclosed apparatuses used to guide hand-held power saws have various deficiencies and limitations that negatively impact the accuracy of the cut, the straightness of the cut, in addition to the portability and versatility of the apparatuses, and the ease of using the apparatuses. Many apparatuses require the complicated assembly of many parts, or must be used with yet other products such as clamps. Other apparatuses have parts that are highly susceptible to wear and tear through use and likely to require replacement or repair. Apparatuses requiring much hand-eye coordination for alignment are not user-friendly as they may be confusing, tedious or difficult to manipulate, particularly for those with poorer eyesight, reduced mobility, unsteady hands, or limited dexterity. It is also desirable that a guide not have any parts which may move during the cut and, thus, affect the alignment.

U.S. Pat. No. 5,226,345 issued to Gamble discloses a portable guide for hand power saws. The invention discloses two guide bars for holding the workpiece in place, one of which guide bars is movable with the use of kerf gauges. Using the kerf gauges, the movable guide bar, and multiple different materials, complicates the design of the guide and increases the expense of its production. The invention has parts which are, as stated in the Gamble patent, subject to wear and tear and will require replacement. The kerf gauges add time to the process for obtaining a cut as the wingnuts on the kerf gauges must be tightened and loosened for each use. The edges used to guide the power saw do not necessarily extend beyond the guide bars and, thus, do not ensure a straight cut through-out as the power saw is not properly supported in alignment at the start and end of the cut. Only two angular alignments are allowed by the invention.

There exists a market for a product that is portable and convenient for the home handyperson to use for guiding a hand-held power saw to produce straight and accurate cuts at commonly desired angles. Further, it is desirable that the product be easy to assemble, easy to manipulate, inexpensive and not susceptible to significant wear and tear.

### SUMMARY OF THE INVENTION

The present invention comprises a portable apparatus for guiding a hand-held power saw for obtaining straight and accurate cuts at commonly desired angles. The apparatus comprises a platform having an upper face and a lower face, of which the upper face is operative to receive a downward force, while the lower face is operative to engage a workpiece. Two spaced apart parallel runners extend perpendicularly from the lower face of the platform. A first guiding strip is situated in a plane parallel to the platform when the first guiding strip is in engagement with the runners, forming a first pre-determined angle with the runners. The first guiding strip has a first guiding edge situated on a side of the first guiding edge, which first guiding edge is operative to guide the base of a hand-held power saw in a straight line at said first pre-determined angle. Similarly, the apparatus is also comprised of a second guiding strip which is situated in a plane parallel to the platform when in engagement with the runners. The second guiding strip then transverses the runners at a second pre-determined angle, and a second guiding edge, situated on the side of the second guiding strip, is operative to guide the base of a hand-held power saw in a straight line at the second pre-determined angle. The runners are operative to elevate said platform from a work surface, to guide and engage an elongated edge of the workpiece, and to support and position the base of a hand-held power saw in the plane of the upper surface of the workpiece.

Other objects and advantages of the invention will become clear from the following detailed description of the preferred embodiment, which is presented by way of illustration only and without limiting the scope of the invention to the details thereof.

### BRIEF DESCRIPTION OF THE DRAWINGS

FIG. 1 is a top view of the apparatus in accordance with the invention.

FIG. 2 is a cross section of the apparatus from a side view.

FIG. 3 is a side view of a guiding strip.

FIG. 4 is a top view of the apparatus depicting the use of a hand-held power saw to cut a sixty degree angle on a workpiece.

FIG. 5 is a top view of the apparatus depicting use of the apparatus with the Black & Decker Workmate 400 (Trademark).

FIG. 6 is a perspective view of an alternative peg.

FIG. 7 is a perspective view of a peg lock.

FIG. 8 is a side view of a runner.

FIG. 9 is a perspective view of a workpiece cut at one end at two angles for a double-angled cut.

### DETAILED DESCRIPTION OF THE INVENTION

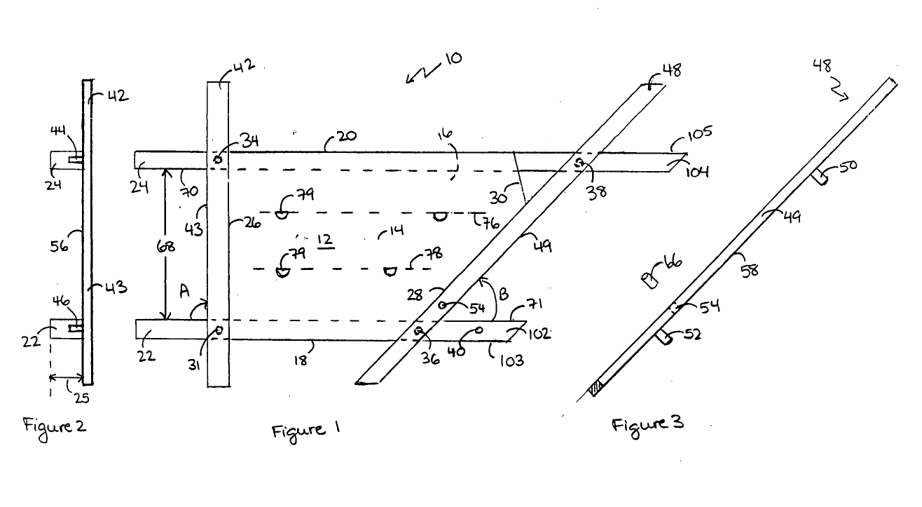

Referring to FIGS. 1-3, guiding apparatus 10 has a platform 12 with an upper face 14 and a lower face 16, and edges 18, 20, 26, 28 and 30, of which edges 18 and 20 run parallel to each other. Referring to FIG. 2, runners 22 and 24 extend perpendicularly to the lower face 16 a distance 25 of 1⅜ inches. The distance 68 between inner edges 70 and 72 of runners 22 and 24 respectively, is 5⅝ inches.

Runner 22 extends longitudinally beyond edges 26 and 28, and runner 24 extends longitudinally beyond edges 26 and 30. Runner 22 has peg holes 31, 36 and 40 on its upper surface, and runner 24 has peg holes 34 and 38 on its upper surface. Guiding strip 42 has guiding edge 43, and pegs 44 and 46, which extend perpendicularly to lower surface 56 of guiding strip 42 and are operative to engage peg holes 34 and 31, respectively, to form an angle A of ninety degrees between guiding strip 42 and runners 22 and 24. Similarly, guiding strip 48 has guiding edge 49, and pegs 50 and 52, which extend perpendicularly to lower surface 58 of guiding strip 48 to engage peg holes 38 and 36, respectively, to form an angle B of forty-five degrees between guiding strip 48 and runners 22 and 24. So, positioned, guiding strip 48 extends longitudinally in the same direction as edge 28 of platform 12.

In an alternate positioning of guiding strip 48, angle C of sixty degrees is formed between guiding strip 48 and runners 22 and 24 when peg 66 engages peg hole 54 in guiding strip 48 and peg hole 40 in runner 22, and peg 50 engages peg hole 38. Edge 30 of platform 12 allows guiding strip 48 to use peg hole 38 for configurations for obtaining each of angles B and C.

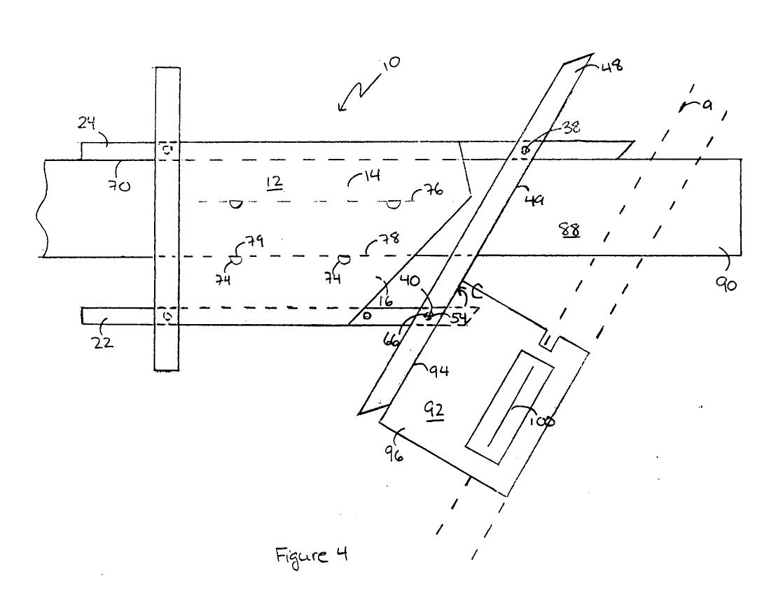

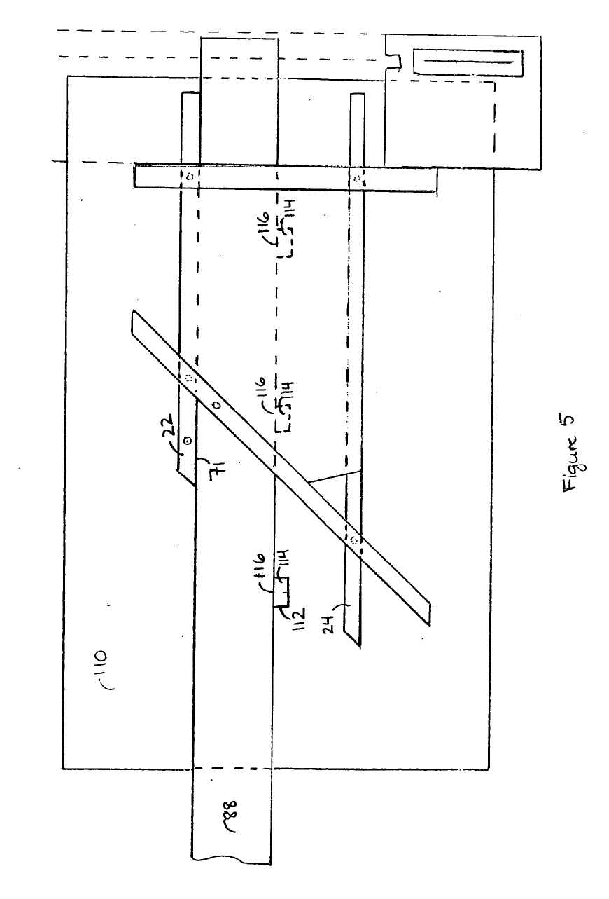

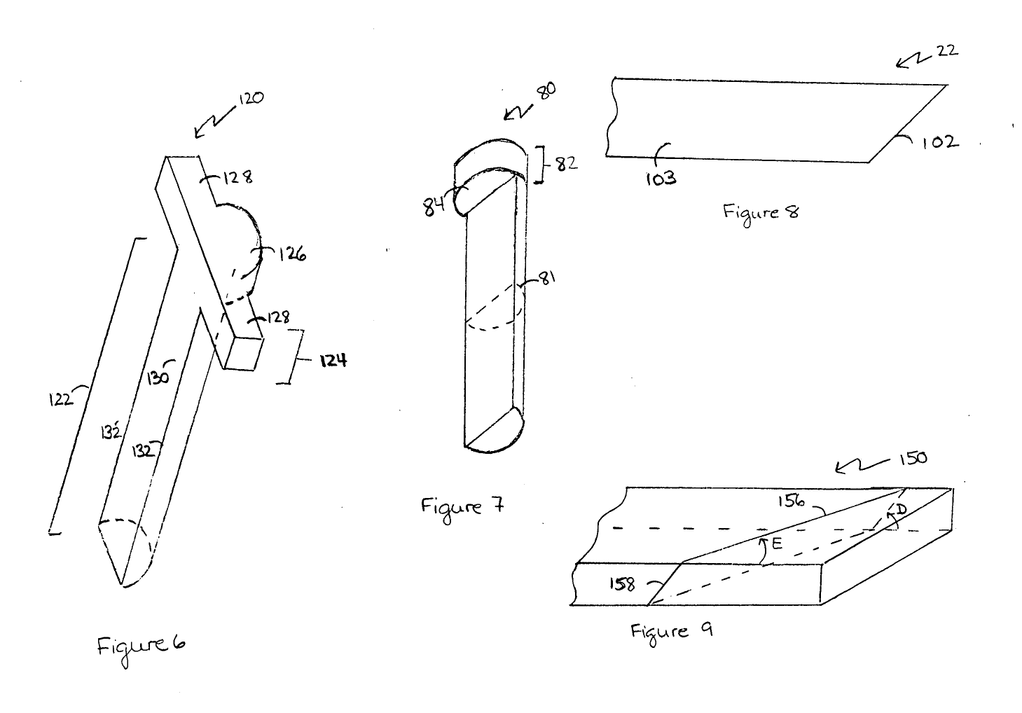

Referring to FIGS. 1 and 4, runners 22 and 24 extend longitudinally beyond guiding strip 42, and also extend longitudinally beyond guiding strip 48 when guiding strip 48 engages runners 22 and 24 to form each of a forty-five degree angle B and a sixty degree angle C. Ends 102 and 104 of runners 22 and 24, respectively, are tapered at a forty-five degree angle in a line parallel to guiding strip 48 when guiding strip 48 is engaged with runners 22 and 24 at forty-five degree angle. Guiding strips 42 and 48 extend longitudinally beyond runners 22 and 24 when in engagement with runners 22 and 24.

Platform 12 has peg lock holes 74 that are semi-circular in shape and arranged along lines 76 and 78. Lines 76 and 78 run parallel to runners 22 and 24. At least two peg lock holes 74 are situated along each of lines 76 and 78. Peg lock holes 74 have straight edges 79 which are proximal to runner 24. Between inner edge 70 and the straight edges 79 of those peg lock holes 74 in row 76 is a distance of 1½ inches. The distance between inner edge 70 and straight edges 79 of those peg lock holes 74 along line 78 is 3½ inches. Referring to FIG. 7, peg locks 80 have a semi-circular longitudinal cross-section 81 and are operative to engage peg lock holes 74 from above upper face 14, and to extend past lower face 16 of platform 12. Each of peg locks 80 have a cap 82 that is circular in shape, each cap 82 having a shoulder 84 operative to prevent peg locks 80 from falling entirely through peg lock holes 74 in platform 12.

During use, platform 12 is placed on top of a workpiece such that the workpiece is situated between runners 22 and 24, and lower face 16 of platform 12 rests on the workpiece. Platform 12 is oriented, and guiding strips 42 and 48 are engaged with runners 22 and 24, in accordance with the desired angle of the cut.

For example, referring to FIG. 4, to obtain a sixty degree angle cut on workpiece end 90 of a 2×4 workpiece 88 using a hand-held power saw 92, guiding apparatus 10 is placed over 2×4 workpiece 88 such that the ends 102 and 104 of runners 22 and 24 are proximal to workpiece end 90. Guiding strip 48 is engaged with runners 22 and 24 by inserting peg 50 into peg hole 38 and peg 66 into peg holes 40 and 54. Guiding apparatus 10 may be aligned with 2×4 workpiece 88 by sliding guiding apparatus 10 longitudinally along 2×4 workpiece 88. Once 2×4 workpiece 88 is aligned and placed against edge 70 of runner 24, 2×4 workpiece 88 is held in place by peg locks 80 inserted into peg lock holes 74 along line 78, the multiple peg locks 74 and the straight edges 91 of peg locks 80 operative to prevent lateral movement of 2×4 workpiece 88.

Downward pressure is applied by hand onto upper face 14 of platform 12 such that lower face 16 of platform 12 engages top face 91 of 2×4 workpiece 88, and friction between lower face 16 and top face 91 operates to hold 2×4 workpiece 88 in place against guiding apparatus 10. Hand-held power saw 92 is aligned for the cut by resting the bottom of saw base plate 96 on runner 22 with base edge 94 of base plate 96 in contact with guiding edge 49 of guiding strip 48. Blade 100 of hand-held power saw 92 is set in motion prior to blade 100 engaging 2×4 workpiece 88. While keeping base edge 94 in contact with guiding edge 49 of guiding strip 48, and base plate 96 on top of runner 22, hand-held power saw 92 is moved in the direction along line a to engage and cut 2×4 workpiece 88. Guiding strip 48 extends a distance beyond runners 22 and 24 sufficient to allow for a straight and accurate start and finish to the cut.

A cut at an angle of one hundred twenty degrees may be obtained using guiding apparatus 10 in the same configuration as described above, but by rotating 2×4 workpiece 88 one hundred eighty degrees around its longitudinal axis. Guiding apparatus 10 is prepared for a cut at an angle of forty-five degrees (or one hundred thirty-five degrees, upon rotating 2×4 workpiece 88 one hundred eight degrees around the longitudinal axis of 2×4 workpiece 88) by positioning guiding strip 48 such that peg 50 engages peg hole 38 and peg 66 engages peg holes 54 and 40. Similarly, guiding apparatus 10 may be used to obtain a cut at ninety degrees using guiding strip 42. Multiple cuts along 2×4 workpiece 88 may be executed merely be sliding either guiding apparatus 10 or 2×4 workpiece 88 along the longitudinal axis of 2×4 workpiece 88. Guiding apparatus 10 is designed to have few moving parts and to allow easy and quick alignment that is easily maintained during its use.

Platform 12 is shaped as having five edges in order to provide a large surface area of lower face 16 for engaging a workpiece and holding the workpiece in place when downward pressure is applied to upper face 14, while also allowing for guiding strip 48 to be positioned in two different ways to obtain angles B and C. To allow for greater friction and better positioning, lower face 16 may be either textured or coated to provide a non-abrasive non-slip surface suitable for engaging a workpiece.

The extension of guiding strips 42 and 48 beyond runners 22 and 24 allows for a clean start and follow-through for the desired cut. Runners 22 and 24 provide upward support for base plate 96 to assist with guiding hand-held power saw 92 in alignment with the plane of the upper surface of a workpiece.

A typical hand-held power saw 92 having a base plate 96 with a base edge 94, and a blade 100, has a distance between base edge 94 and blade 100 that is between 5 inches and 5/2 inches. For a hand-held power saw 92 with a distance between base edge 94 and blade 100 that is 5¼ inches, the preferred length, perpendicular to each of guiding strip 42 and guiding strip 48, by which runners 22 and 24 extend beyond guiding strips 42 and 48 in a direction away from platform 12 is not less than 1 inch and not greater than 3½ inches. The maximum of 3/2 inches is specified to allow tilting of blade 100 up to an angle of 45 degrees to allow for a double-angled cut such as the cut as shown in FIG. 9. According to FIG. 9, workpiece 150 is cut along lines 156 on its upper surface at an angle E of sixty degrees, and along line 158 on the side edge of workpiece 150 at an angle D of forty-five degrees. Referring to FIGS. 1 and 8, an alternative embodiment that allows for a maximum upper surface to runners 22 and 24 while allowing for a double-cut is one in which ends 102 and 104 of runners 22 and 24, respectively, are tapered along outside edges 103 and 105 at an angle of forty-five degrees, such that runners 22 and 24 extend beyond guiding strips 42 and 48 in a direction away from platform 12 no greater than 4/2 inches at the upper surfaces of runners 22 and 24, and no greater than 3/2 inches at the lower surfaces of runners 22 and 24. For hand-held power saws of different dimensions, apparatus 10 may be modified such that the dimensions of runners 22 and 24 complement the dimensions of the particular hand-held power saw.

The guiding apparatus 10 may be used for workpieces of various sizes. Platform 12 may have additional peg lock holes at various distances from edge 70 of runner 24 for the purpose of holding workpieces of various widths. A 2×2 workpiece (not shown) may be cut using the peg lock holes 74 along line 76 to hold it in place. The width of guiding apparatus 10 also allows use for cutting a 2×6 workpiece (not shown) of actual dimensions 1½ inches by 5/2 inches by allowing for distance 68 of 5⅝ inches. For workpieces wider than a 2×6, guiding apparatus 10 may be designed so that distance 68 is greater than 5⅝ inches. To allow a user to hold a workpiece against either of runners 22 and 24, additional peg lock holes (not shown) may be allowed such that the additional peg lock holes are placed at various desirable distances from runner 22. Alternatively, rectangular peg holes (not shown) and rectangular peg locks (not shown) may be used and spaced such that each rectangular peg hole may be used to hold a workpiece against either of runners 22 and 24.

Workpieces that are of a depth less than 1½ inches, such as mouldings and trim, may be cut using guiding apparatus 10 by placing such a workpiece on a filler piece, preferably of a width equal to or approximating the distance between runners 22 and 24, that allows the upper surface of such a workpiece to be engaged by lower face 16 of platform 12, while also decreasing the likelihood of lateral movement of the workpiece during the execution of a cut. Alternatively, lumber that is of a depth of ¾ inches, such as 1×2, 1×4 and 1×6 pieces, may be doubled up to have one of the lumber pieces act as filler.

To allow an even more secure engagement of a workpiece by peg locks 80, peg locks 80 may be modified in design in accordance with FIG. 6 of alternative peg 120. Alternative peg 120 has a body 122 and head 124. Head 124 has a shoulder 126 and extensions 128 operative to prevent alternative peg 120 from falling entirely through peg lock holes 74 in platform 12. Extensions 128 extend outwardly from the longitudinal axis of body 122 in a direction perpendicular to the straight edges 132 of body 122 such that head 124 and body 122 share a t-shaped flat face 130.

Alternative peg 120 is operative to engage a peg lock hole 74 from above upper face 14, and to extend past the lower face 16 of platform 12, or, alternatively, to engage a peg lock hole 74 from lower surface 16. When alternative peg 120 engages a peg lock hole 74 from lower surface 16, head 124 rests on the work surface on which a workpiece rests, and t-shaped flat face 130 provides a surface operative to engage workpiece and to prevent workpiece from twisting or moving laterally during execution of a cut.

Cross-sectional shapes other than those indicated above may be used for peg locks 80 (or alternative pegs 120) and peg lock holes 74. For example, peg locks 80 may be cylindrical or rectangular pyramidal in shape, and peg lock holes 74 may accordingly be circular or rectangular in shape. However, it is preferable that peg locks 80 have flat faces, and, consequently, that peg lock holes 74 have a flat edges to complement peg locks 80, as flat faces on peg locks 80 engage workpieces more securely than rounded faces, preventing a workpiece from twisting or moving laterally during the execution of a cut.

There are no screws required during use of apparatus 10 and no clamps or kerfs required to hold the workpiece in place.

While use of peg lock holes 74 and peg locks 80 decreases the likelihood of lateral movement, sufficient downward pressure on upper face 14 of guiding apparatus 10 also serves to keep a workpiece from moving. Distance 25 of 1⅜ inches allows for a substantial surface area on edge 70 for engaging a workpiece, while ensuring that lower face 16 may engage the upper surface of standard lumber workpieces such as 2×2, 2×4 and 2×6 pieces, which have actual depths of 1½ inches.

Alternatively, apparatus 10 may be used with a work table such as the Black & Decker Workmate 400 (Trademark) to facilitate holding a workpiece in place and preventing lateral movement during a cut. Referring to FIG. 5, the Black & Decker Workmate 400 (Trademark) has a table surface 110 having perforations 112 for the insertion of accessories 114. For example, in using apparatus 10 in conjunction with Black & Decker Workmate 400 (Trademark) to facilitate a cut in 2×4 workpiece 88 at a ninety degree angle, one side of 2×4 workpiece 88 is placed against edge 71 of runner 22 while the opposite side of 2×4 workpiece 88 is placed against edges 116 of accessories 114, and force is applied to maintain this alignment.

While a uni-positional guiding strip, such as guiding strip 42, may be more permanently attached to runners 22 and 24, for packaging and storage purposes, it is preferred that guiding strips 42 and 48 be detachable. Guiding apparatus 10 may also be modified to allow for various other cut angles.

Use of guiding apparatus 10 does not require the use of triangles, protractors and other aids for measuring angles in order to obtain straight and accurate cuts for commonly used angles. There are few components to guiding apparatus 10 allowing for ease of use.

In the preferred embodiment, injection-moulded plastic would be used to make a durable, light-weight, inexpensive and precision-crafted guiding apparatus 10. Alternatively, guiding apparatus 10 may be made of wood such that platform 12 is firmly secured to runners 22 and 24 using, for example, screws or nails and that pegs 44, 46, 50 and 52 are attached using, for example, glue or nails to upon insertion them into bored holes (not shown) in guiding strips 42 and 48. While guiding apparatus 10 may also be constructed using metal, a balance would have to be reached between the rigidity of the metal, to ensure guiding apparatus 10 holds its shape, and the weight of guiding apparatus 10, to ensure that guiding apparatus 10 is not too heavy and that its portability is not unduly impacted.

This invention has been described with reference to illustrative embodiments, rather than restrictive embodiments. Accordingly, this description is not intended to be construed in a limiting sense. Various modifications to the illustrative embodiments, as well as other embodiments of the invention, will be apparent to a person skilled in the art upon reference to this description. The scope of the invention is indicated by the appended claims rather than the foregoing description and all such modifications or embodiments that come within the meaning and range and equivalence thereof are intended to be embraced therein.

1. An apparatus for guiding a hand-held power saw, the apparatus comprising:
a) a platform having an upper face and a lower face, said upper face operative to receive a downward force and said lower face operative to engage a workpiece;
b) two spaced apart parallel runners extending perpendicularly from said lower face of said platform, each of said runners extending longitudinally across said platform and beyond said platform;
c) a first guiding strip situated in a plane parallel to said platform when said first guiding strip is in engagement with said runners, said first guiding strip transversing said runners at a first pre-determined angle;
d) a first guiding edge situated on a side of said first guiding strip, said first guiding edge operative to guide the base of a hand-held power saw in a straight line at said first pre-determined angle;
e) a second guiding strip situated in a plane parallel to said platform when said second guiding strip is in engagement with said runners, said second guiding strip transversing said runners at a second pre-determined angle; and
f) a second guiding edge situated on a side of said second guiding strip, said second guiding edge operative to guide the base of a hand-held power saw in a straight line at said second pre-determined angle;
wherein said runners are operative to elevate said platform from a work surface, to guide and engage an elongated edge of the workpiece, and to support and position the base of a hand-held power saw in the plane of the upper surface of the workpiece.

2. The apparatus according to claim 1, wherein said first pre-determined angle is ninety degrees.

3. The apparatus according to claim 2, wherein said second pre-determined angle is forty-five degrees.

4. The apparatus according to claim 1, wherein said second guiding strip is movable to a position in which said second guiding strip engages and transverses said runners at a third pre-determined angle.

5. The apparatus according to claim 4, wherein said first guiding strip is movable to a position in which said first guiding strip engages and transverses said runners at a fourth pre-determined angle.

6. The apparatus according to claim 4, wherein said third pre-determined angle is an angle of sixty degrees.

7. The apparatus according to claim 1, wherein said first guiding strip and said second guiding strip each extend across said runners and beyond either side thereof to allow each of said first guiding edge and said second guiding edge to guide the base of the hand-held power saw in a straight line prior to the blade of the hand-held power saw engaging the workpiece, as the blade cuts through the workpiece, and until the blade entirely leaves the workpiece.

8. The apparatus according to claim 1, wherein said apparatus further comprises peg-locks, and said platform has peg-lock holes that allow the insertion of said peg-locks, said peg-locks operative to hold the workpiece in place to prevent lateral movement of the workpiece.

9. The apparatus according to claim 8, wherein each of said peg-locks has an inserting portion which is passable through the peg-lock holes, said inserting portion having a cross-section with a flat edge, said flat edge operative to engage the workpiece.

10. The apparatus according to claim 9, wherein said cross-section is semi-circular in shape.

11. The apparatus according to claim 8, wherein said each of said peg-locks has a shoulder at one end, said shoulder operative to sit on said upper face of said platform to prevent said each of said peg-locks from passing entirely through the peg-lock holes in said platform.

12. The apparatus according to claim 8, wherein said platform has at least one row of at least two peg-lock holes, each said row running parallel to said runners.

13. The apparatus according to claim 12, wherein said platform has a first said row distanced 1.5 inches from a first of said runners.

14. The apparatus according to claim 13, wherein said platform has a second said row distanced 3.5 inches from said first of said runners.

15. The apparatus according to claim 1, wherein said apparatus is made of injection-moulded plastic.

16. The apparatus according to claim 1, wherein said apparatus is made of wood.

17. The apparatus according to claim 1, wherein said apparatus is made of metal.

18. The apparatus according to claim 1, wherein said platform and said runners form one piece.

19. The apparatus according to claim 8, wherein said peg-locks are made of injection-moulded plastic.

20. The apparatus according to claim 4, wherein said second guiding strip engages said runners to form said second pre-determined angle such that said second guiding strip engages a first of said runners at a first engagement point and a second of said runners at a second engagement point, and wherein said second guiding strip engages said runners to form said third pre-determined angle such that said second guiding strip engages said first of said runners at said first engagement point and said second of said runners at a third engagement point.

21. The apparatus according to claim 1, further comprising:
a) said runners having engaging holes on their upper surfaces;
b) said guiding strips having engaging notches on their lower surfaces; and
c) pegs operative to each insert into one of the engaging holes and one of the engaging notches, said pegs operative to hold said guiding strips in engagement with said runners.

22. The apparatus according to claim 1, wherein said guiding strips and said runners have complementary holes and engaging extensions, the holes and said engaging extensions operative to hold said guiding strips in engagement with said runners.

23. The apparatus according to claim 20, wherein said platform has five edges such that said first guiding strip aligns with a first edge of said platform when said first guiding strips is in engagement with said runners at said first pre-determined angle, and said second guiding strip aligns with a second edge of said platform when said second guiding strip is in engagement with said runners at said second pre-determined angle, and wherein said second guiding strip aligns with a third edge of said platform when said second guiding strip is in engagement with said runners at said third pre-determined angle.

24. The apparatus according to claim 4, wherein said runners extend across and beyond either side of said first guiding strip when said first guiding strip engages said runners at said first pre-determined angle, and extend across and beyond either side of said second guiding strip when said second guiding strip engages said runners at either of said second pre-determined angle and said third pre-determined angle.

25. The apparatus according to claim 1, wherein said runners extend a first distance perpendicular to said first guiding edge and distal to said platform, and a second distance perpendicular to said second guiding edge and distal to said platform, and wherein said first distance and second distance are each no greater than the distance from the edge of the base of the hand-held power saw to the blade of the hand-held power saw, less ¼ inches.

26. The apparatus according to claim 25, wherein said runners have tapered ends cut at forty-five degree angles such that lower surfaces of said runners extend a third distance perpendicular to said first guiding edge and distal to said platform, and a fourth distance perpendicular to said second guiding edge and distal to said platform, and wherein said third distance and said fourth distance are each no greater than the distance from the edge of the base of the hand-held power saw to the blade of the hand-held power saw, less 1¾ inches.

27. The apparatus according to claim 9, wherein each of said peg-locks has a head situated at one end of said each of said peg-locks, said head comprising:
a) extensions extending perpendicularly to the longitudinal axis of said each of said peg-locks; and
b) a flat surface, said flat surface being situated in plane with said flat edge;
wherein said extensions each have an edge that forms a portion of said flat surface.

28. The apparatus according to claim 27, wherein said head is operative to rest on the work surface and wherein said flat surface is operative to engage the workpiece to prevent lateral movement of the workpiece.

29. The apparatus according to claim 28, wherein said extensions are operative to sit on said upper face of said platform to prevent said each of said peg-locks from passing entirely through the peg-lock holes in said platform.

30. The apparatus according to claim 1, wherein said runners extend perpendicularly from said lower surface of said platform a distance of 1⅜ inches.

31. The apparatus according to claim 1, wherein inner sides of said runners, each of said inner sides facing the other of said inner sides, have between them a distance of 5⅝ inches.
